(19) United States
(12) Patent Application Publication
(10) Pub. No.: US 2020/0082394 A1
(43) Pub. Date: Mar. 12, 2020

(54) METHOD AND SYSTEM FOR PROCESSING PAYMENT TRANSACTIONS

(71) Applicant: MASTERCARD INTERNATIONAL INCORPORATED, Purchase, NY (US)

(72) Inventors: Navneet Jain, Pune (IN); Piyush Sharma, Pune (IN)

(73) Assignee: MASTERCARD INTERNATIONAL INCORPORATED, Purchase, NY (US)

(21) Appl. No.: 16/534,108

(22) Filed: Aug. 7, 2019

(30) Foreign Application Priority Data
Sep. 7, 2018 (SG) 10201807739V

(51) Int. Cl. G06Q 20/38; G06Q 20/10; G06Q 20/40; G06Q 30/02

(52) U.S. Cl. CPC G06Q 20/3821; G06Q 30/0238; G06Q 20/401; G06Q 20/102

(57) ABSTRACT

A method for processing on-behalf transactions is provided. A first merchant registers to avail an on-behalf transaction service offered by a server. The first merchant initiates an on-behalf transaction for a purchase that a customer wants to make with the first merchant, who possesses a point-of-sale (POS) device which currently is mal-functioning or does not possess the POS device for performing cashless transactions. The first merchant provides transaction details initiating the on-behalf transaction. The server generates a transaction code based on the transaction details. The first merchant provides the transaction code to the customer, who in turn provides the transaction code to a second merchant, who possesses the POS device. The server verifies the transaction code provided by the second merchant. The server further initiates the on-behalf transaction based on successful verification of the transaction code.

### FIELD OF THE INVENTION

The present invention relates generally to payment transactions, and, more particularly, to methods and systems for processing electronic payment transactions.

### BACKGROUND

Due to the advent of technology, cashless modes of payments have witnessed an upward trend. Customers find the cashless modes of payments more convenient, as they do not have to carry cash with them for making purchases. Due to the convenience offered by the cashless modes of payments to the customers, merchants have installed various terminal devices, such as point-of-sale (POS) or point-of-interaction (POI) devices, for accepting cashless payments. Typically, such terminal devices employ magnetic stripe readers or electronic chip readers that process transaction cards, such as credit cards, debit cards, cash cards and the like. The terminal devices can be used for performing contactless payments by using key fobs, smartphones, and other similar electronic devices that use radio-frequency identification (RFID) or near field communication (NFC) technologies.

However, installation of terminal devices may be expensive and often requires additional infrastructure (in terms of?). Especially in developing countries, merchants either have no knowledge of such terminal devices or lack knowledge of handling them. As a result, many merchants still prefer to accept cash payments for various purchases. In such a scenario, if customers wish to purchase products and/or services from these merchants, the customers have to always ensure that they carry sufficient cash with them to make purchases. This may be troublesome for some customers as they may not prefer to carry the cash and hence would opt for a different merchant that accepts payment by means of electronic transactions. Thus, merchants who do not possess terminal devices suffer losses, both in terms of customers and revenue. In addition, lack of adequate number of merchants who possess terminal devices causes inconvenience to the customers as they have to search around for the merchants who possess such terminal devices.

In light of the foregoing, there exists a need for a solution that enables a merchant, who possesses a terminal device which currently is mal-functioning or does not possess the terminal device, to receive payments from customers for purchases by way of cashless transactions.

### SUMMARY

In an embodiment of the present invention, a method for processing transactions is provided. Transaction details for a transaction are received, by a server, from a merchant device of a first merchant. The transaction details are associated with a purchase that a customer wants to make with the first merchant. A transaction code is generated in response to the received transaction details and is communicated to the first merchant. The first merchant further provides the transaction code to the customer. The transaction code, provided by the customer, is further received from a terminal device of a second merchant. The transaction code, received from the terminal device, is further verified by the server. When the transaction code is successfully verified, the transaction is initiated, by the server, based on a payment mode used by the customer to perform the transaction. Further, a purchase amount corresponding to the purchase is debited from a customer account associated with the payment mode, when the transaction is approved. Further, a transaction offer is allocated to the second merchant after conducting the transaction.

In another embodiment of the present invention, a system for processing transactions is provided. The system includes a server that includes a processor. The processor receives transaction details of a transaction, for a purchase that a customer wants to make with a first merchant, from a merchant device of the first merchant. The processor generates a transaction code in response to the received transaction details and communicates the transaction code to the first merchant. The first merchant further provides the transaction code to the customer. The processor further receives the transaction code, provided by the customer, from a terminal device of a second merchant. The processor further verifies the transaction code received from the terminal device. On successful verification of the transaction code, the processor initiates the transaction based on a payment mode used by the customer to perform the transaction. Further, a purchase amount corresponding to the purchase is debited from a customer account associated with the payment mode, when the transaction is approved. Further, a transaction offer is allocated to the second merchant after conducting the transaction.

In yet another embodiment of the present invention, a method for processing transactions is provided. Transaction details for a transaction are received, by a server, from a merchant device of a first merchant. The transaction details are associated with a purchase that a customer wants to make with the first merchant at a first merchant location. A transaction code is generated in response to the received transaction details and is communicated to the first merchant. The first merchant provides the transaction code to the customer. The transaction code is received, by the server, from a terminal device of a second merchant, when the customer provides the transaction code to the second merchant at a second merchant location. The received transaction code is verified by the server. Based on successful verification of the transaction code, account identification information of a customer account corresponding to a payment mode used by the customer to perform the transaction is received from the terminal device. The transaction is initiated based on the account identification information. Further, a purchase amount corresponding to the purchase is debited from the customer account of the customer, when the transaction is approved. Further, a transaction offer is allocated to the second merchant after conducting the transaction.

### BRIEF DESCRIPTION OF THE DRAWINGS

The accompanying drawings illustrate various embodiments of systems, methods, and other aspects of the invention. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present invention are illustrated by way of example, and not limited by the appended figures, in which like references indicate similar elements, and in which:

FIG. 1 is a block diagram that illustrates an environment for processing transactions, in accordance with an embodiment of the present invention;

FIG. 2 is a block diagram that illustrates a payment network server of the environment of FIG. 1, in accordance with an embodiment of the present invention;

FIG. 3 is a process flow diagram that illustrates a registration process for registering a first merchant with the payment network server for availing an on-behalf transaction service, in accordance with an embodiment of the present invention;

FIGS. 4A and 4B, collectively, represent a process flow diagram that illustrates an exemplary scenario for processing transactions, in accordance with an embodiment of the present invention;

FIG. 5 is a process flow diagram that illustrates a method for settling an on-behalf transaction, in accordance with an embodiment of the present invention;

FIG. 6 is a flow chart that illustrates a method for registering a first merchant with the payment network server for availing an on-behalf transaction service, in accordance with an embodiment of the present invention;

FIGS. 7A and 7B, collectively, represent a flow chart that illustrates a method for processing transactions, in accordance with an embodiment of the present invention;

FIG. 8 represents a flow chart that illustrates a method for settling an on-behalf transaction, in accordance with an embodiment of the present invention;

FIG. 9 represents a high-level flow chart that illustrates a method for processing transactions, in accordance with an embodiment of the present invention; and

FIG. 10 is a block diagram that illustrates a system architecture of a computer system, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the present invention.

### DETAILED DESCRIPTION

The present invention is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example” and so on, indicate that the embodiment (s) or example (s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Overview

In various exemplary scenarios, a customer may want to purchase products and/or services from a first merchant who currently does not have provisions for performing electronic payment transactions using transaction cards. In such scenarios, the customer, who wants to pay for the purchase from the first merchant using her transaction card, may be forced to pay for the products and/or services using cash, which may not be desirable to the customer. Thus, the customer may approach any other merchant to make the same purchase, which results into loss of customer and revenue to the first merchant. Moreover, cash transactions may preclude use of transaction cards for payment transactions that require terminal devices (e.g., point-of-sale (POS) devices) equipped with electronic payment infrastructures. As the electronic payment infrastructures may increase cost and maintenance of the terminal devices for the first merchant, who generally have a small margin of profit, there is a need to obviate the installation of a terminal device for every first merchant.

Various embodiments of the present invention provide a method and a system for processing electronic payment transactions. The electronic payment transactions may be performed by individuals, such as merchants, using POS devices for purchases that customers want to make with the merchants. In an embodiment of the present invention, the first merchant registers with a payment network for availing an on-behalf transaction service. In one example, the first merchant may register with the payment network, when the first merchant does not possess a POS device. In another example, the first merchant may register with the payment network, when the first merchant possesses the POS device which currently is not functioning due to reasons, such as network unavailability, power failure, faulty machines, or the like.

The first merchant may be associated with a first merchant store at a first merchant location and offers sale of products and/or services to the customers. The customer who makes a purchase from the first merchant, may want to make payment for the purchase using an electronic payment mode, for example, by using a transaction card. However, the first merchant cannot accept the payment using the transaction card of the customer because the POS device of the first merchant is not functioning or the first merchant does not possess the POS device. In such a scenario, the first merchant uses her merchant device (e.g., a smartphone) to initiate an on-behalf transaction for the purchase. The first merchant inputs transaction details of the on-behalf transaction for the purchase by means of a service application installed on the merchant device. The transaction details include at least one of a purchase amount of the purchase or merchant details of the first merchant.

A server receives the transaction details from the merchant device by means of the service application. The server generates a transaction code for the on-behalf transaction in response to the received transaction details. The server further transmits the transaction code to the merchant device. The first merchant provides the transaction code to the customer. The customer goes to a second merchant store associated with a second merchant, who possesses a POS device for performing cashless transactions. The second merchant store may be associated with a second merchant location. The customer provides the transaction code to the second merchant. The second merchant inputs the transaction code by way of an interface on the POS device. The POS device transmits the transaction code to the server. The server receives the transaction code from the POS device and verifies the transaction code. Upon successful verification of the transaction code, the server communicates the second merchant that the transaction code has been successfully verified. Thereafter, the second merchant may prompt the customer to use her transaction card to perform the on-behalf transaction using the POS device. In another example, the second merchant may use the transaction card of the customer to perform the on-behalf transaction on behalf of the customer. The POS device reads account identification information of a customer account associated with the customer and transmits the account identification information of the customer account to the server. The server receives the account identification information of the customer account from the POS device. The server further initiates the on-behalf transaction based on the received account identification information. The server initiates an authorization request for authorizing the on-behalf transaction. The server further initiates an authentication request for authenticating the customer. Upon successful authorization of the on-behalf transaction and/or successful authentication of the customer, the purchase amount is debited from the customer account.

Further, the server may determine merchant account details of a merchant account associated with the first merchant based on the merchant details. The server may further initiate credit of the purchase amount to the merchant account based on the merchant account details. The server further allocates a transaction offer to the second merchant after successful processing of the on-behalf transaction. The transaction offer is pertinent to one or more new transactions other than a new on-behalf transaction that may be conducted by the second merchant after successful processing of the on-behalf transaction. In an exemplary embodiment, the transaction offer is associated with a merchant discount rate (MDR) that may be waived-off on the one or more new transactions. The MDR is a processing fee that is charged to a merchant, such as the second merchant, for payment processing services on transactions using electronic payment modes, for example, using transaction cards. The transaction offer allocated to the second merchant may expire based on at least one of time or usage limit associated with the transaction offer.

Thus, the method and the system, in accordance with various embodiments of the present invention, facilitates merchants (who do not possess POS devices, or possess the POS devices which currently are mal-functioning) to accept cashless transactions from the customers by way of an on-behalf transaction service.

### Terms Description (In Addition to Plain and Dictionary Meaning)

Server is a physical or cloud data processing system on which a server program runs. A server may be implemented in hardware or software, or a combination thereof. In one embodiment, the server is implemented as a computer program that is executed on programmable computers, such as personal computers, laptops, or a network of computer systems. The server may correspond to a merchant server, an acquirer server, a payment network server, an issuer server, or a digital wallet server.

Merchant is an entity that offers various products and/or services in exchange of payments. The merchant may establish a merchant account with a financial institution to accept payments from several customers.

Issuer is a financial institution where accounts of several customers are established and maintained. The issuer ensures payment for authorized transactions in accordance with various payment network regulations and local legislation.

Payment network is a transaction card association that acts as an intermediate entity between acquirers and issuers to authorize and fund transactions. Examples of payment networks include Mastercard®, American Express®, VISA®, Discover®, Diners Club®, and the like. The Payment network settles transactions between various acquirers and issuers, when transaction cards are used for initiating transactions. The payment network ensures that a transaction card used by a customer for initiating a transaction is authorized.

Payment mode refers to a means of payment using which a customer performs transactions for various purchases. Examples of the payment mode includes a transaction card or an electronic wallet (hereinafter, e-wallet). The transaction card is a payment device, such as a debit card, a credit card, a prepaid card, a promotional card, a contactless card, and/or other device that may hold identification information of an account. The transaction card can be used by the customer to perform transactions, such as deposits and withdrawals, credit transfers, purchase payments, and the like. In an embodiment, the transaction card may be radio-frequency identification (RFID) or near field communication (NFC) enabled for performing contactless payments. The e-wallet refers to a digital wallet that holds electronic cash. The e-wallet can be used to perform transactions for various purchases.

On-behalf transaction is a type of transaction that allows a first merchant, who does not possess a terminal device (for example, a Point-of-Sale (POS) device), to receive payment from a customer for a purchase, when the customer wants to use an electronic payment mode, for example, a transaction card to make the payment for the purchase. For initiating the on-behalf transaction, the first merchant provides transaction details, including at least a purchase amount of the purchase, by means of a service application installed on a merchant device of the first merchant. The service application may be associated with one of a merchant server, an acquirer server, a payment network server, an issuer server, or a digital wallet server. A transaction code is generated in response to the transaction details. Examples of the transaction code include a one-time password (OTP), a quick response (QR) code, a bar code, and the like. The first merchant provides the transaction code to the customer. An on-behalf transaction process corresponding to the purchase is conducted, when the customer provides the transaction code to a second merchant, who possesses a terminal device for performing cashless transactions.

Terminal device is a computing device, for example, a point-of-sale (POS) device, a point-of-interaction (POI) device, a point-of-purchase (POP) device, and/or a near field communication (NFC) POS device, which is used by a merchant to facilitate electronic transactions. The terminal device may be installed in a merchant store of the merchant for performing the electronic transactions.

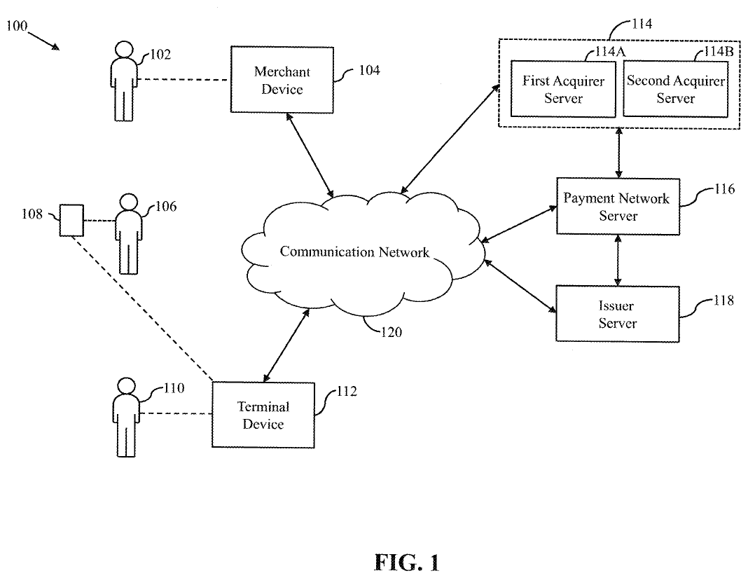

Various exemplary embodiments of the present invention have been further described in detail with reference to FIGS. 1 to 10.

FIG. 1 is a block diagram that illustrates an environment 100 for processing transactions, in accordance with an embodiment of the present invention. The environment 100 includes a first merchant 102 in possession of a merchant device 104, a customer 106 in possession of a transaction card 108, and a second merchant 110 in possession of a terminal device 112. The environment 100 further includes acquirer servers 114 (such as a first acquirer server 114A and a second acquirer server 114B), a payment network server 116, and an issuer server 118. The merchant device 104, the terminal device 112, the first acquirer server 114A, the second acquirer server 114B, the payment network server 116, and the issuer server 118 may communicate with each other by way of a communication network 120 or separate communication networks established therebetween.

The first merchant 102 is an individual, who sells products and/or services to various customers, such as the customer 106, in exchange of payments. The first merchant 102 may be associated with a first merchant store at a first merchant location where the first merchant 102 sells the products and/or services. In one exemplary embodiment, the first merchant store may be a retail shop, a restaurant, a supermarket, a government agency, or any other individual business entity, such as a street vendor, that do not facilitate a merchant terminal (e.g., a POS device) for performing electronic transactions using electronic payment modes, such as using transaction cards. In another exemplary embodiment, the first merchant 102 possesses the merchant terminal but may not access the merchant terminal for performing the electronic transactions due to software snafus, power failure, network issue, or the like. Thus, in one scenario, the first merchant 102 accepts cash as a means of payment from the customers who want to pay in cash for purchases made from the first merchant 102. In another scenario, the first merchant 102 allows the customers to perform on-behalf transactions, when the customers want to make payments using the electronic payment modes. For accepting payments by way of the on-behalf transactions, the first merchant 102 requires a bank account. For example, the first merchant 102 is an account holder of a first merchant account. The first merchant account is a bank account maintained by a financial institution, such as a first acquirer. The first merchant account may be associated with identification information (hereinafter, “account identification information of the first merchant account”) that includes an account number, a name of an account holder (i.e., the first merchant 102), or the like.

Before initiating the on-behalf transactions, the first merchant 102 registers with a payment network (e.g., Mastercard) for availing an on-behalf transaction service that enables the first merchant 102 to carry out the on-behalf transactions. The first merchant 102 may initiate a registration request for registration with the payment network. Such registration is a one-time process that has to be completed before allowing the first merchant 102 to perform the on-behalf transactions for the customers who want to make payments using the electronic payment modes. The first merchant 102 accesses a mobile application and/or a website on the merchant device 104 to initiate the registration request. The mobile application is a set of computer executable codes that may be installed in a memory (not shown) of the merchant device 104. The website is a group of web pages that are published on one or more web servers. The mobile application and/or the website may be associated with the payment network and the merchant device 104 communicates with the payment network by means of the mobile application and/or the website. For registration, the first merchant 102 may submit her registration information, such as a name, a contact number, an email ID, and the account identification information, with the payment network server 116 by way of the mobile application and/or the website. Upon successful registration, the first merchant 102 may accept payments from the customers by means of the on-behalf transactions.

The merchant device 104 is a communication device associated with the first merchant 102. Examples of the merchant device 104 include, but are not limited to, a mobile phone, a smartphone, a laptop, a tablet, a phablet, a desktop computer, or any other communication device known in the art. The first merchant 102 uses the merchant device 104 to access the mobile application and/or the website associated with the payment network. The merchant device 104 may be associated with registered contact information of the first merchant 102 that is linked to the first merchant account. In one example, the registered contact information includes a registered contact number of the first merchant 102. In another example, the registered contact information includes a registered email ID of the first merchant 102. The first merchant 102 uses the mobile application and/or the website on the merchant device 104 to initiate the registration process for registering for the on-behalf transaction service that enables the first merchant 102 to accept payments by means of the on-behalf transactions.

Upon successful completion of the registration process, the first merchant 102 may initiate an on-behalf transaction request using the mobile application and/or the website on the merchant device 104. For example, the first merchant 102 initiates the on-behalf transaction request for the customer 106 who wants to make a payment for a purchase using the transaction card 108. To initiate the on-behalf transaction request, the first merchant 102 inputs transaction details associated with the purchase using the merchant device 104. The transaction details may include at least a purchase amount associated with the purchase. The transaction details may further include merchant details of the first merchant 102. The merchant details may include merchant information, such as the name, the registered contact information, the account identification information, or the like, of the first merchant 102. In one embodiment, the first merchant 102 may enter the merchant details along with the purchase amount. In another embodiment, the merchant details may be retrieved from a storage server associated with the payment network that facilitates the on-behalf transaction service to the first merchant 102. The merchant device 104 transmits the on-behalf transaction request including the transaction details to the payment network server 116 by means of the mobile application and/or the website. In response to the on-behalf transaction request, the merchant device 104 receives a transaction code from the payment network server 116 associated with the payment network by way of the mobile application, the website, a short message service (SMS), an email, or the like. Examples of the transaction code include, but are not limited to, a one-time password (OTP), a quick response (QR) code, a bar code, or a combination thereof. Thereafter, the first merchant 102 provides the transaction code to the customer 106. The first merchant 102 may further direct the customer 106 to the second merchant 110 to complete the transaction for the purchase.

The customer 106 is an individual, who is an account holder of a customer account. In one embodiment, the customer account is a bank account maintained by another financial institution, such as an issuer. The issuer may further issue the transaction card 108 to the customer 106 for performing electronic transactions from the customer account. The transaction card 108 is linked to the customer account and stores identification information of the customer account (hereinafter, “account identification information of the customer account”) in form of an electronic chip or a machine readable magnetic strip. The account identification information may include an account number, a name of an account holder (i.e., the customer 106), or the like. The transaction card 108 further has a unique card number, an expiry date, a card security code, and a card type associated to it. The unique card number, the expiry date, the card security code, and the card type correspond to details of the transaction card 108. In one scenario, the transaction card 108 is a physical card, such as a credit card, a debit card, a membership card, a charge card, an electronic cash card, a gift card, or the like. In another scenario, the transaction card 108 may be a virtual transaction card that is stored in a memory (not shown) of a customer device (not shown) of the customer 106. In another embodiment, the customer account is an e-wallet account maintained by an e-wallet service provider. In such a scenario, the e-wallet account is linked to an e-wallet (not shown) that is loaded with electronic cash. The transaction card 108 or the e-wallet corresponds to the electronic payment mode that may be used by the customer 106 to make the payment for the purchase with the first merchant 102.

The second merchant 110 is an individual, who sells products and/or services to various customers, such as the customer 106, in exchange of payments. The second merchant 110 may be associated with a second merchant store at a second merchant location where the second merchant 110 sells the products and/or services. In an exemplary embodiment, the second merchant store may be a retail shop, a restaurant, a supermarket, a government agency, or any other individual business entity, such as a street vendor, that facilitates a merchant terminal, such as the terminal device 112, to perform electronic transactions using electronic payment modes, such as using transaction cards. In such a scenario, the second merchant 110 accepts both cash and transaction cards as means of payment based on customer's discretion. For accepting payments made by way of the transaction cards, the second merchant 110 needs to have a bank account. For example, the second merchant 110 is an account holder of a second merchant account. The second merchant account is a bank account maintained by yet another financial institution, such as a second acquirer. The second merchant account may be associated with identification information (hereinafter, “account identification information of the second merchant account”) that includes an account number, a name of an account holder (i.e., the second merchant 110), or the like. The second merchant 110 may further allow the terminal device 112 to be used for conducting the on-behalf transactions initiated by other merchants, (for example, the first merchant 102) for purchases made therefrom.

Before allowing the terminal device 112 to be used for conducting the on-behalf transactions, the second merchant 110 initiates a registration request with the payment network and registers for conducting the on-behalf transaction service. Such registration may be a one-time process that has to be completed before allowing the terminal device 112 to be used for conducting on-behalf transactions. For registration, the second merchant 110 may submit her registration information, such as a name, a contact number, an email ID, and the account identification information, with the payment network server 116. Upon successful registration, the second merchant 110 may use the terminal device 112 for performing the on-behalf transactions. The second merchant 110 may receive one or more benefits or offers from the payment network for conducting the on-behalf transactions. For example, the second merchant 110 may be freed from a merchant discount rate (MDR) or merchant service fee (MSF) associated with one or more new transactions other than a new on-behalf transaction. The MDR or MSF is a processing fee that is charged to the second merchant 110 for payment processing services on transactions using electronic payment modes, for example, the transaction card 108. Also, it may create a positive impact in her ratings in a MATCH database associated with the payment network.

The terminal device 112 is an electronic device that is used by the second merchant 110 to perform various electronic transactions. Examples of the terminal device 112 include, but are not limited to, a POS device, a POI device, a POP device, and the like. The terminal device 112 may be configured to present various transaction options, such as first and second transaction options, that are selectable by the second merchant 110 to perform the corresponding transactions. The first transaction option allows the second merchant 110 to conduct electronic transactions corresponding to payments for purchases that are made by customers from the second merchant 110. The second transaction option allows the second merchant 110 to conduct the electronic transactions (i.e., the on-behalf transactions) corresponding to payments for purchases that are made by customers from other merchants, such as the first merchant 102. For example, the customer 106 requests the second merchant 110 for conducting the on-behalf transaction for the purchase that the customer 106 wants to make with the first merchant 102. For conducting the on-behalf transaction, the second merchant 110 selects the second transaction option on the terminal device 112. Upon selecting of the second transaction option, the terminal device 112 presents a user interface (not shown) to the second merchant 110. The second merchant 110 inputs the transaction code, provided by the customer 106, by way of the user interface. Upon successful verification of the transaction code by the payment network server 116, the terminal device 112 receives the transaction details, including at least the purchase amount of the purchase made by the customer 106 with the first merchant 102, from the payment network server 116. Thereafter, the second merchant 110 conducts the on-behalf transaction for the customer 106 using the transaction card 108. The terminal device 112 reads the account identification information of the customer account of the customer 106 held by the transaction card 108. Further, the terminal device 112 transmits a transaction request corresponding to the on-behalf transaction to one of the second acquirer server 114B, the payment network server 116, or the issuer server 118 to process and settle the on-behalf transaction. In an event of insufficient funds in the customer account, the transaction request is declined and the terminal device 112 displays a notification representing decline of the transaction request.

The first acquirer server 114A is a computing server that is associated with the first acquirer. The first acquirer maintains the first merchant account associated with the first merchant 102. The first acquirer processes authorization and transaction requests, received from a first merchant server (not shown) by using the first acquirer server 114A. The first acquirer server 114A transmits the transaction requests to payment networks or issuers associated with customer accounts from which the corresponding transactions are performed, via the communication network 120. The first acquirer server 114A credits the first merchant account in the first acquirer with a transaction amount, when the corresponding transaction is settled.

The second acquirer server 114B is a computing server that is associated with the second acquirer. The second acquirer maintains the second merchant account associated with the second merchant 110. The second acquirer processes authorization and transaction requests, received from a second merchant server (not shown) by using the second acquirer server 114B. The second acquirer server 114B transmits the transaction requests to payment networks or issuers associated with customer accounts from which the corresponding transactions are performed, via the communication network 120. The second acquirer server 114B credits the second merchant account in the second acquirer with a transaction amount, when the corresponding transaction is settled.

The payment network server 116 is a computing server that is associated with a payment network of various transaction cards. The payment network server 116 represents an intermediate entity between the first and second acquirer servers 114A and 114B and the issuer server 118 for authorizing and funding the transactions performed by using the transaction cards. In one embodiment, the payment network server 116 hosts the mobile application and/or the website which enables the customers (such as the customer 106) to register their payment modes (such as transaction cards and/or e-wallets) for making purchases with various merchants, such as the first and second merchants 102 and 110. The mobile application and/or the website further offer/s the on-behalf transaction service to the merchants, who do not possess the terminal devices, such as the terminal device 112, for conducting the electronic transactions and have registered for such services with the payment network server 116.

In an exemplary scenario, a merchant, such as the first merchant 102 initiates the on-behalf transaction request for the purchase that the customer 106 wants to make from the first merchant 102. The first merchant 102 inputs the transaction details of the purchase by way of the mobile application and/or the website. The payment network server 116 receives the transaction details from the merchant device 104 by way of the mobile application and/or the website and generates the transaction code for the on-behalf transaction requested by the first merchant 102. The payment network server 116 communicates the transaction code to the first merchant 102. The first merchant 102 further provides the transaction code to the customer 106 to make the payment for the purchase. In one example, the first merchant 102 may direct the customer 106 to the second merchant 110 (who possesses the terminal device 112) to make the payment for the purchase using the transaction card 108. In another example, the customer 106 may travel to a merchant, such as the second merchant 110 (who possesses the terminal device 112) to make the payment for the purchase using the transaction card 108. The transaction code may be associated with a validity period, for example, 2 hours, 5 hours, or 24 hours, within which the customer 106 may have to make the payment through the second merchant 110 to complete the transaction for the purchase.

The payment network server 116 receives the transaction code, inputted by the second merchant 110, from the terminal device 112, when the customer 106 provides the transaction code to the second merchant 110. The payment network server 116 verifies the transaction code and upon successful verification, retrieves the transaction details associated with the transaction code. Further, the payment network server 116 presents the transaction details, for example, the purchase amount of the purchase, to the terminal device 112. The payment network server 116 further receives the account identification information of the customer account associated with the transaction card 108 from the terminal device 112, when the second merchant 110 uses the transaction card 108 to conduct the transaction for the purchase using the terminal device 112 (or when the customer 106 uses her transaction card 108 to perform the transaction using the terminal device 112). The payment network server 116 initiates an authentication of the customer 106 based on the received account identification information. Upon successful authentication, the transaction may be approved. Thereafter, the purchase amount corresponding to the purchase is debited from the customer account of the customer 106. The payment network server 116 flags the transaction as an on-behalf transaction and parks the purchase amount, debited from the customer account, at its end. The payment network server 116 further determines the merchant account details, for example, the account identification information of the first merchant account associated with the first merchant 102 based on the merchant details. Based on the merchant account details, the payment network server 116 initiates a credit of the purchase amount to the first merchant account of the first merchant 102.

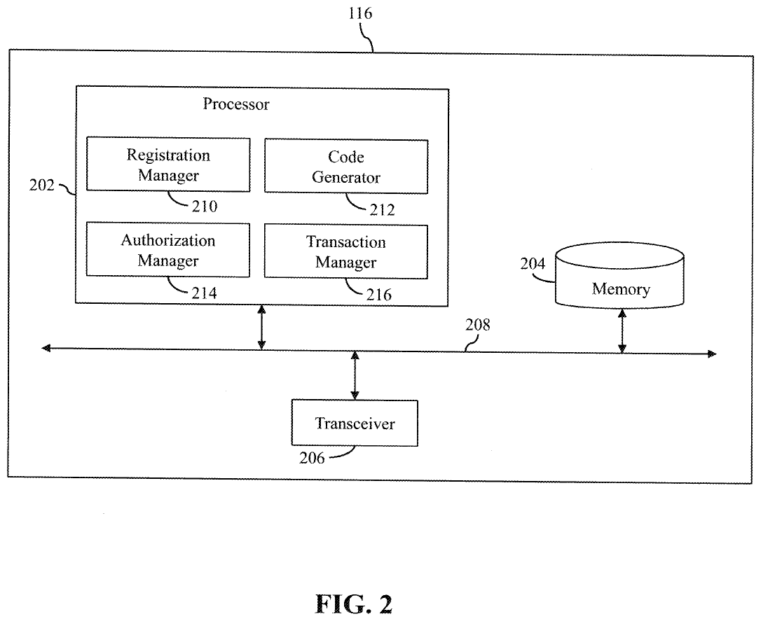

The payment network server 116 communicates the credit and/or debit of the purchase amount to the first acquirer server 114A, the second acquirer server 114B, and the issuer server 118 to indicate crediting and/or debiting of the customer account, the first merchant account, and/or the second merchant account corresponding to the transaction performed from the customer account. The payment network server 116 further allocates a transaction offer to the second merchant 110 upon successful processing of the on-behalf transaction. The payment network server 116 communicates the transaction offer to the second merchant 110. The transaction offer may be applicable to the one or more new transactions other than the new on-behalf transaction conducted by the second merchant 110 after successful processing of the on-behalf transaction. The transaction offer is associated with the MDR that is waived-off on the one or more new transactions. The transaction offer may expire based on at least one of time or usage limit associated with the transaction offer. The components and functioning of the payment network server 116 are explained in conjunction with FIG. 2. Examples of various payment networks include Mastercard, American Express, VISA, Discover, Diners Club, and the like.

The issuer server 118 is a computing server that is associated with the issuer. The issuer is a financial institution that manages accounts of multiple customers, such as the customer 106. Account details of the accounts established with the issuer are stored as account profiles in a memory (not shown) of the issuer server 118 or on a cloud server associated with the issuer server 118. The account details may include an account balance, a credit line, details of an account holder, transaction history of the account holder, account identification information, details of transaction cards linked to the corresponding customer account, or the like. The details of the account holder may include name, age, gender, physical attributes, registered contact number, alternate contact number, registered email address, or the like of the account holder. In an embodiment, the account details are stored in an encrypted format to ensure data security to the customers. The issuer server 118 receives various credit and debit requests from the payment network server 116. Based on the credit and debit requests, the issuer server 118 credits or debits the corresponding customer accounts of the customers, such as the customer 106.

Examples of the first acquirer server 114A, the second acquirer server 114B, the payment network server 116, and the issuer server 118, include, but are not limited to, computers, laptops, mini-computers, mainframe computers, any non-transient and tangible machines that can execute a machine-readable code, cloud-based servers, distributed server networks, or a network of computer systems.

The communication network 120 is a medium through which content and messages are transmitted between various entities, such as the merchant device 104, the terminal device 112, the first acquirer server 114A, the second acquirer server 114B, the payment network server 116, and the issuer server 118. Examples of the communication network 120 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, or any combinations thereof. Various entities in the environment 100 may connect to the communication network 120 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, or any combination thereof

FIG. 2 is a block diagram that illustrates the payment network server 116 of the environment 100 of FIG. 1, in accordance with an embodiment of the present invention. The payment network server 116 includes a processor 202, a memory 204, and a transceiver 206 that communicate with each other via a communication bus 208.

The processor 202 includes suitable logic, circuitry, and/or interfaces to execute operations for facilitating electronic transactions performed by using various electronic payment modes, such as transaction cards or e-wallets. The processor 202 performs such operations by means of hardware techniques, and/or under the influence of program instructions stored in the memory 204. In an embodiment, the processor 202 hosts the mobile application or the website, which is executable on merchant devices (such as the merchant device 104), for offering the on-behalf transaction service to the merchants (such as the first merchant 102). The processor 202 includes a registration manager 210, a code generator 212, an authorization manager 214, and a transaction manager 216 for offering the on-behalf transaction service to the merchants and facilitating the corresponding transactions performed by the customers. Examples of the processor 202 include, but are not limited to, an application-specific integrated circuit (ASIC) processor, a reduced instruction set computing (RISC) processor, a complex instruction set computing (CISC) processor, a field-programmable gate array (FPGA), and the like.

The memory 204 includes suitable logic, circuitry, and/or interfaces to store information of partner issuers, acquirers, and partner merchants. The memory 204 further stores merchant profiles of various merchants, such as the first merchant 102 and the second merchant 110, who have registered for the on-behalf transaction service. The memory 204 further stores the customer profiles of the customers, such as the customer 106, who have registered their payment modes with the payment network server 116. A customer profile of a customer, such as the customer 106, includes information of the customer 106 and information pertaining to the payment mode registered by the customer 106. Such information is stored in an encrypted format to ensure data security to the customers. The memory 204 further stores a set of codes, instructions, programs, or the like, which enables the processor 202 to host the mobile application or the website. Examples of the memory 204 include a random-access memory (RAM), a read-only memory (ROM), a removable storage drive, a hard disk drive (HDD), a flash memory, a solid-state memory, and the like.

It will be apparent to a person skilled in the art that the scope of the invention is not limited to realizing the memory 204 in the payment network server 116, as described herein. In another embodiment, the memory 204 may be realized in form of a database server or a cloud storage working in conjunction with the payment network server 116, without departing from the scope of the present invention.

The transceiver 206 includes suitable logic, circuitry, and/or interfaces that transmits and receives data over the communication network 120 using one or more communication network protocols under the control of the processor 202. The transceiver 206 transmits/receives various requests and messages to/from the merchant device 104, the terminal device 112, the first and second acquirer servers 114A and 114B, the issuer server 118, or other entities that are pursuant to one or more standards for the interchange of transaction messages (such as the ISO8583 standard). Examples of the transceiver 206 include, but are not limited to, an antenna, a radio frequency transceiver, a wireless transceiver, a Bluetooth transceiver, an ethernet port, a universal serial bus (USB) port, or any other device configured to transmit and receive data.

The registration manager 210 includes suitable logic, circuitry, and/or interfaces to execute operations for facilitating registration of various merchants, such as the first and second merchants 102 and 110, who want to use the on-behalf transaction service offered by the payment network. The registration manager 210 declines the registration of a merchant account, when the merchant account is not verified by an entity (such as an acquirer). The registration manager 210 creates and updates the merchant profiles of the merchants (such as the first and second merchants 102 and 110) who have registered for the on-behalf transaction service with the payment network server 116.

The code generator 212 includes suitable logic, circuitry, and/or interfaces to execute operations for facilitating generation of transaction codes for the on-behalf transactions initiated by the merchants, such as the first merchant 102. Each transaction code generated during a defined time duration (for example, a day) is a unique code that does not match with other transaction codes generated during the same day. Further, each transaction code is associated with a validity period, and thus the corresponding on-behalf transaction should be conducted before expiry of the validity period. Each transaction code and the corresponding merchant details are stored in an encrypted format in the memory 204.

The authorization manager 214 includes suitable logic, circuitry, and/or interfaces to execute operations for facilitating authorization of the transactions, for example, the on-behalf transactions that are conducted by the merchants (such as the second merchant 110) using the transaction cards (such as the transaction card 108) provided by the customers (such as the customer 106). The authorization manager 214 initiates an authorization request for authorizing the corresponding transaction, and thereafter, communicates the authorization request to the corresponding customer, such as the customer 106. The authorization manager 214 does not authorize the transaction, when the customer 106 declines the transaction. The authorization manager 214 authorizes the transaction, when the customer 106 approves the transaction.

The transaction manager 216 includes suitable logic, circuitry, and/or interfaces to execute operations for facilitating generation of the credit or debit requests based on the corresponding transactions that are authorized. The transaction manager 216 communicates the credit or debit requests to the acquirer servers 114 (such as the first acquirer server 114A and/or the second acquirer server 114B) and the issuer server 118 by way of the transceiver 206. The transaction manager 216 further initiates blocking of a certain amount (for example, the purchase amount associated with the purchase) from a customer account (for example, the customer account associated with the customer 106).

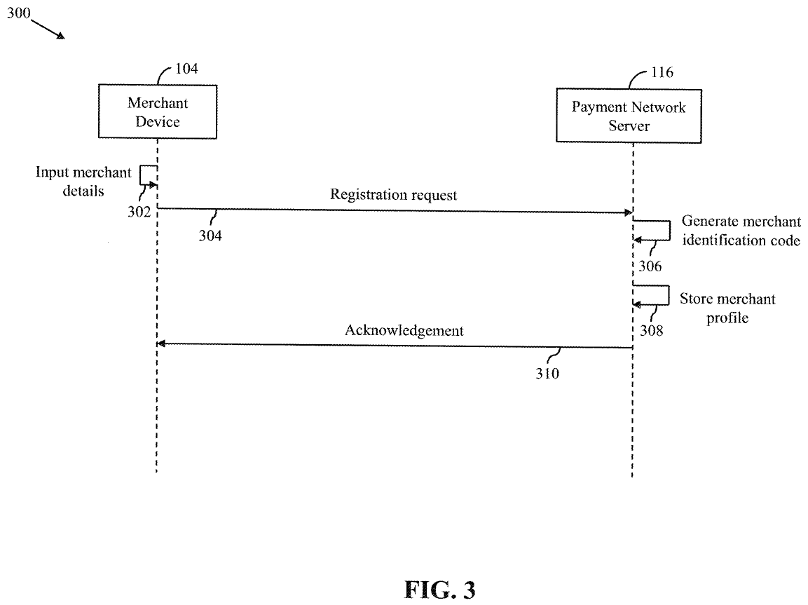

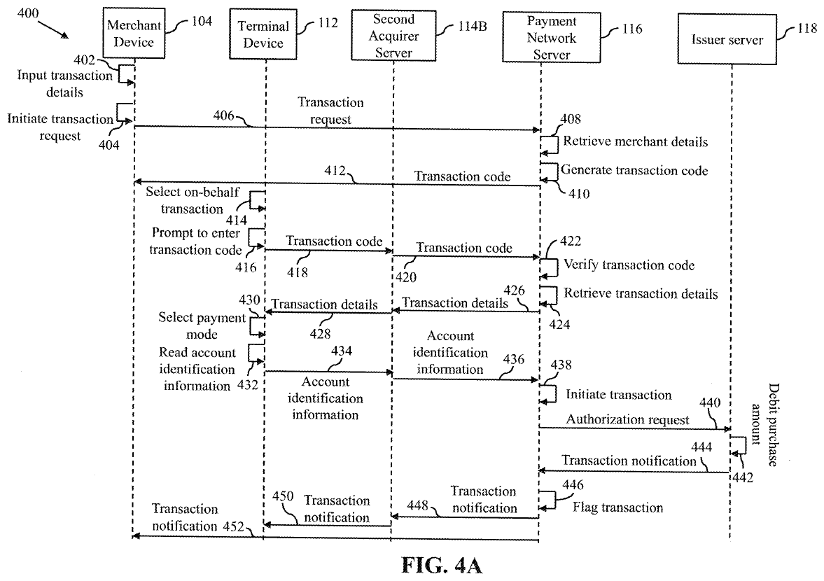

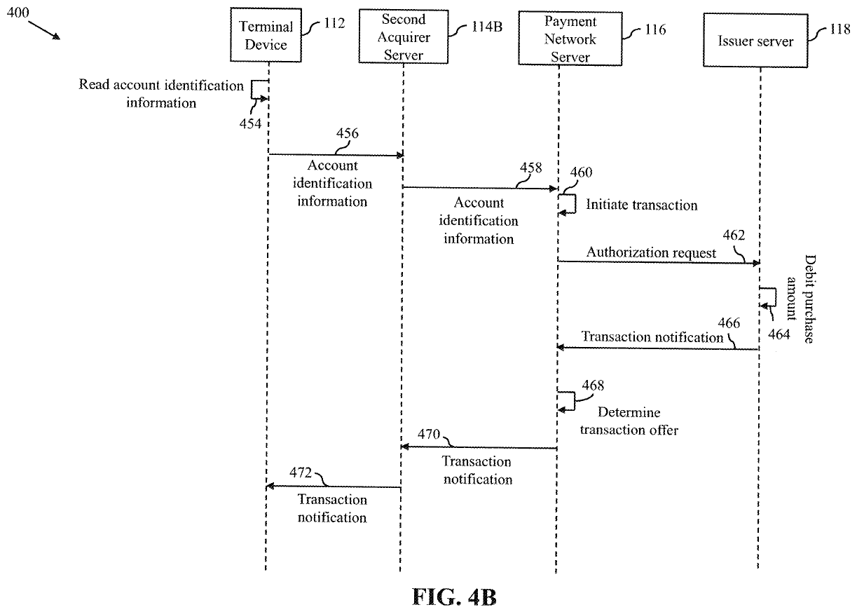

It will be apparent to a person skilled in the art that a third-party server that may host the mobile application and/or the website for facilitating the on-behalf transactions by offering the on-behalf transaction service to the merchants may also be implemented by the block diagram of FIG. 2, without deviating from the scope of the invention. It will be further apparent to a person skilled in the art that an acquirer server, such as the first acquirer server 114A, may host the mobile application or the website for facilitating the on-behalf transactions by offering the on-behalf transaction services to the merchants in a manner similar to the payment network server 116. However, in such a scenario, the customers, such as the customer 106, who wants to make the purchase from the first merchant 102 having the first merchant account associated with the first acquirer server 114A, needs to go to the second merchant 110 having the second merchant account associated with the same first acquirer server 114A, for performing the on-behalf transaction. The functions performed by the payment network server 116 are explained in conjunction with FIGS. 3, 4A, and 4B.

FIG. 3 a process flow diagram 300 that illustrates the registration process for registering the first merchant 102 with the payment network server 116 for availing the on-behalf transaction service, in accordance with an embodiment of the present invention.

The first merchant 102 uses the merchant device 104 to initiate the registration process for the on-behalf transaction service. Prior to the registration process, the first merchant 102 provides login credentials, for example, a merchant identifier (ID) and a password, for logging into the mobile application (for example, a payment network application associated with the payment network, such as, Mastercard) on the merchant device 104. The payment network server 116 validates the login credentials. Upon successful validation, the first merchant 102 is presented with a user interface (not shown) on the merchant device 104 for initiating the registration process. The first merchant 102 inputs the merchant details, for example, the name, the registered contact information, the account identification information, or the like (as shown by arrow 302). The merchant device 104 transmits the registration request (as shown by arrow 304) including the merchant details of the first merchant 102 to the payment network server 116 by way of the mobile application. The transceiver 206 receives the registration request and stores it in the memory 204. The registration manager 210 processes the registration request to initiate registration of the first merchant 102 with the payment network server 116 for the on-behalf transaction service.

The registration manager 210 further generates a merchant identification code for the first merchant 102 (as shown by arrow 306). The registration manager 210 stores the merchant details and the merchant identification code as a merchant profile of the first merchant 102 in the memory 204 (as shown by arrow 308). The registration manager 210 communicates an acknowledgement to the first merchant 102 indicating successful registration of the first merchant 102 with the payment network server 116 (as shown by arrow 310). The acknowledgement may further include the merchant identification code. In one example, the registration manager 210, in conjunction with the transceiver 206, transmits an SMS on the registered contact number of the first merchant 102 for communicating the acknowledgement. In another example, the registration manager 210 sends an email on the registered email ID of the first merchant 102 for communicating the acknowledgement. The registration process for registering the second merchant 110 with the payment network server 116 for using the on-behalf transaction service is similar to the registration process of the first merchant 102, as described above.

FIGS. 4A and 4B, collectively, represent a process flow diagram 400 that illustrates an exemplary scenario for processing transactions, in accordance with an embodiment of the present invention. The process flow diagram 400 illustrates the merchant device 104, the terminal device 112, the second acquirer server 114B, the payment network server 116, and the issuer server 118. The first merchant 102 sells the products and/or services in the first merchant store at the first merchant location. The customer 106 may want to purchase a product from the first merchant 102. The customer 106 further may further want to make the payment for the purchase using the transaction card 108. However, in one embodiment, the first merchant 102 does not possess a POS device for performing the transaction using the transaction card 108 of the customer 106. In another embodiment, the first merchant 102 possesses the POS device which currently is mal-functioning (due to various reasons, such as network unavailability, power failure, faulty machines, or the like), and hence cannot perform the transaction using the transaction card 108 of the customer 106. In such scenarios, the first merchant 102 accesses the mobile application (or the website) of the payment network server 116 on the merchant device 104 and initiates the on-behalf transaction for the customer 106.

The first merchant 102 inputs the transaction details, including at least one of the purchase amount of the purchase or the merchant details, by way of the mobile application (as shown by arrow 402) and initiates the on-behalf transaction request (as shown by arrow 404). The on-behalf transaction request corresponds to a request for initiating the on-behalf transaction and includes the transaction details. The merchant device 104 transmits the on-behalf transaction request to the payment network server 116 (as shown by arrow 406). The transaction manager 216 retrieves the merchant details of the first merchant 102 from the memory 204 based on the on-behalf transaction request (as shown by arrow 408). For example, the on-behalf transaction request may include the merchant ID of the first merchant 102. Based on the merchant ID of the first merchant 102, the transaction manager 216 identifies the merchant identification code of the first merchant 102, which is further used to retrieve the merchant details of the first merchant 102 from the memory 204. In another example, the on-behalf transaction request may include the merchant identification code of the first merchant 102, which can be further used to identify the first merchant 102 and retrieve the merchant details of the first merchant 102 from the memory 204.

Further, the code generator 212 generates the transaction code for the on-behalf transaction initiated by the first merchant 102 (as shown by arrow 410). The code generator 212 stores a copy of the transaction code against the merchant ID or the merchant identification code of the first merchant 102 in the memory 204. Further, the transceiver 206 transmits the transaction code to the merchant device 104 (as shown by arrow 412). The first merchant 102 provides the transaction code to the customer 106. In one example, the first merchant 102 may direct the customer 106 to the second merchant 110. In another example, the first merchant 102 may provide location information of the second merchant 110, who has been identified by the payment network server 116. In yet another example, the customer 106 may travel to the second merchant 110 based on her preference.

Upon reaching the second merchant location associated with the second merchant 110, the customer 106 provides the transaction code to the second merchant 110. The second merchant 110 selects the second transaction option (i.e., an on-behalf transaction option) on the user interface of the terminal device 112 (as shown by arrow 414). The terminal device 112 prompts the second merchant 110 to enter the transaction code (as shown by arrow 416). The second merchant 110 inputs the transaction code provided by the customer 106. The terminal device 112 transmits the transaction code to the second acquirer server 114B (as shown by arrow 418). The second acquirer server 114B transmits the transaction code to the payment network server 116 (as shown by arrow 420). The code generator 212 verifies the received transaction code (as shown by arrow 422). For example, the code generator 212 compares the transaction code received from the terminal device 112 with the copy of the transaction code stored in the memory 204. Such comparison of the received transaction code with the stored transaction code may be performed based on the merchant ID or the merchant identification code associated with the transaction code. The process flow diagram 400 illustrates a scenario where the transaction code received from the terminal device 112 matches with the transaction code transmitted to the merchant device 104. Thus, verification of the transaction code is successful. In case verification of the transaction code is not successful, the on-behalf transaction is declined.

Further, the code generator 212 performs a check to determine whether the transaction code is valid or invalid based on the validity period associated with the transaction code. In case the validity period of the transaction code has expired, the on-behalf transaction is declined. However, if the validity period of the transaction code has not expired, the transaction manager 216 retrieves the transaction details (for example, the purchase amount associated with the purchase) from the memory 204 (as shown by arrow 424). The transaction manager 216 further transmits the transaction details to the second acquirer server 114B (as shown by arrow 426). The second acquirer server 114B further transmits the transaction details to the terminal device 112 (as shown by arrow 428). The terminal device 112 displays the transaction details, for example, the purchase amount associated with the purchase.

Upon display of the purchase amount on the terminal device 112, the second merchant 110 may select the payment mode on the terminal device 112 as a transaction card payment mode for conducting the transaction corresponding to the purchase amount (as shown by arrow 430). The second merchant 110 may also prompt the customer 106 to use her transaction card 108 for performing the transaction. The terminal device 112 reads the account identification information of the customer account associated with the transaction card 108 (as shown by arrow 432). The account identification information read by the terminal device 112 includes information, such as the account number, the card number of the transaction card 108, and the like.

The terminal device 112 further transmits the account identification information of the customer account to the second acquirer server 114B (as shown by arrow 434). The second acquirer server 114B further transmits the account identification information of the customer account to the payment network server 116 (as shown by arrow 436). Based on the account identification information of the customer account, the transaction manager 216 identifies the issuer associated with the customer account and initiates the transaction corresponding to the purchase amount (as shown by arrow 438). To initiate the transaction, the authorization manager 214 transmits the authorization request to the issuer server 118 (as shown by arrow 440) to authorize the transaction. In one scenario, the issuer server 118 may perform authentication of the customer 106 before authorizing the transaction. The issuer server 118 may use one or more authentication techniques that are known in the art for authenticating the customer 106. Upon successful authentication of the customer 106 and/or the successful authorization of the transaction, the issuer server 118 debits the purchase amount from the customer account (as shown by arrow 442). The issuer server 118 further transmits a transaction notification indicating successful transaction along with the purchase amount (debited from the customer account) to the payment network server 116 (as shown by arrow 444). The payment network server 116 flags the transaction as the on-behalf transaction (as shown by arrow 446) and parks the purchase amount against the first merchant 102. The payment network server 116 further transmits the transaction notification to the second acquirer server 114B (as shown by arrow 448). In one embodiment, the second acquirer server 114B may also flag the transaction as an on-behalf transaction. The second acquirer server 114B further transmits the transaction notification to the terminal device 112 (as shown by arrow 450). The terminal device 112 presents the transaction notification to the second merchant 110. The payment network server 116 also transmits the transaction notification to the merchant device 104 of the first merchant 102 (as shown by arrow 452).

Upon successful processing of the on-behalf transaction, the payment network server 116 allocates the transaction offer to the second merchant 110. The transaction offer may be pertinent to the one or more new transactions for purchases that the customers want to make from the second merchant 110. In an exemplary embodiment, the transaction offer is associated with the MDR that may be waived-off on the one or more new transactions. The transaction offer may expire based on at least one of the time or usage limit associated with the transaction offer. The payment network server 116 may further communicate the transaction offer to the second merchant 110. For example, the transaction offer may be communicated by means of an SMS on the registered contact number of the second merchant 110 or an email on the registered email ID of the second merchant 110.

In an exemplary scenario, the second merchant 110 uses the terminal device 112 to initiate a new transaction for a new purchase that a new customer wants to make from the second merchant store associated with the second merchant 110. For the simplicity of the ongoing discussion, the customer 106 is considered as the new customer and the transaction card 108 is considered as a new transaction card that is used by the customer 106 to make a payment for the new purchase from the second merchant 110. However, a person skilled in the art will understand that the scope of the present invention is not limited to the customer 106 being the new customer and the transaction card 108 being the new transaction card. The new customer may be any other customer who uses her transaction card to make the payment for the new purchase.

For the new transaction, the terminal device 112 reads the account identification information of the customer account associated with the transaction card 108 (as shown by arrow 454). The account identification information read by the terminal device 112 includes information, such as the account number, the card number of the transaction card 108, and the like. The terminal device 112 further transmits the account identification information of the customer account to the second acquirer server 114B (as shown by arrow 456). The second acquirer server 114B further transmits the account identification information of the customer account to the payment network server 116 (as shown by arrow 458). Based on the account identification information of the customer account, the transaction manager 216 identifies the issuer associated with the customer account and initiates the new transaction corresponding to the purchase amount (as shown by arrow 460). To initiate the new transaction, the authorization manager 214 transmits a new authorization request to the issuer server 118 (as shown by arrow 462) to authorize the new transaction. In one scenario, the issuer server 118 may perform authentication of the customer 106 before authorizing the new transaction. Upon successful authentication of the customer 106 and/or the successful authorization of the new transaction, the issuer server 118 debits a purchase amount (corresponding to the new transaction) from the customer account (as shown by arrow 464). The issuer server 118 further transmits a transaction notification indicating successful transaction along with the purchase amount (debited from the customer account) to the payment network server 116 (as shown by arrow 466).

The payment network server 116 determines the transaction offer associated with the second merchant 110 (as shown by arrow 468). The payment network server 116 further determines that the transaction offer has not expired and can be used for only one transaction. In such a scenario, the payment network server 116 attaches a flag to the transaction notification indicating the transaction offer (i.e., the ongoing transaction is free from MDR charges). The payment network server 116 further transmits the transaction notification to the second acquirer server 114B (as shown by arrow 470). Further, the second acquirer server 114B credits the purchase amount to the second merchant account and does not charge the MDR for the new transaction. The second acquirer server 114B further transmits the transaction notification to the terminal device 112 (as shown by arrow 472) indicating successful processing of the new transaction.

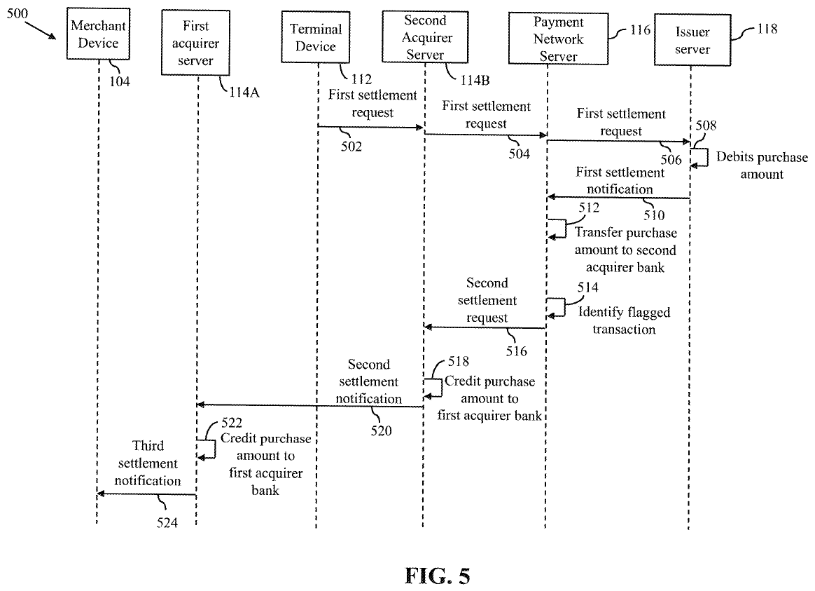

FIG. 5 is a process flow diagram 500 that illustrates a method for settling the on-behalf transactions, in accordance with an embodiment of the present invention. The process flow diagram 500 illustrates the merchant device 104, the terminal device 112, the first acquirer server 114A, the second acquirer server 114B, the payment network server 116, and the issuer server 118. The terminal device 112 transmits a first settlement request to the second acquirer server 114B to settle the on-behalf transactions performed by the second merchant 110 (as shown by arrow 502). The first settlement request includes the transaction details associated with the purchase and the account identification information of the customer account. The process flow diagram 500 illustrates an exemplary scenario where only transaction is being processed for settlement. However, it will be apparent to a person skilled in the art that multiple transactions may be settled in a batch.

The second acquirer server 114B transmits the first settlement request to the payment network server 116 (as shown by arrow 504). The payment network server 116 identifies the issuer based on the account identification information and transmits the first settlement request to the issuer server 118 (as shown by arrow 506). The issuer debits the purchase amount from the customer account of the customer 106 (as shown by arrow 508) and parks the purchase amount with the payment network server 116 or the issuer server 118. The issuer server 118 transmits a first settlement notification to the payment network server 116 (as shown by arrow 510). The payment network transfers the purchase amount to the second acquirer server 114B for performing the settlement (as shown by arrow 512). The payment network server 116 further determines that the purchase amount is associated with a flagged transaction indicating that the transaction is the on-behalf transaction (as shown by arrow 514). The payment network server 116 further transmits a second settlement request to the second acquirer server 114B to instruct the second acquirer to credit the purchase amount to the first merchant account associated with the first merchant 102 (as shown by arrow 516). The second acquirer transfers the purchase amount to the first acquirer (as shown by arrow 518). The second acquirer server 114B transmits a second settlement notification to the first acquirer server 114A, indicating transfer of the purchase amount (as shown by arrow 520) to the first merchant account. The first acquirer further credits the purchase amount to the first merchant account (as shown by arrow 522). The first acquirer server 114A transmits a third settlement notification to the merchant device 104, indicating the credit of the purchase amount to the first merchant account (as shown by arrow 524).

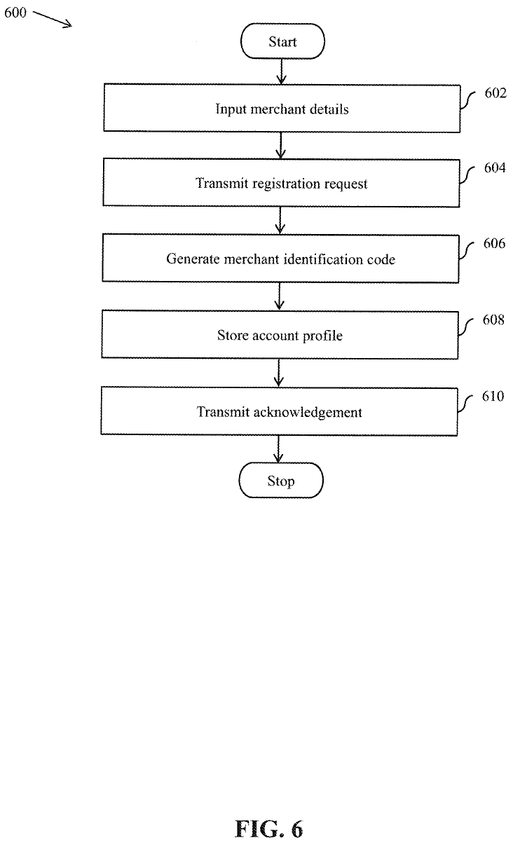

FIG. 6 is a flow chart 600 that illustrates a method for registering the first merchant 102 with the payment network server 116 for availing the on-behalf transaction service, in accordance with an embodiment of the present invention.

At step 602, the first merchant 102 inputs her merchant details to initiate the registration request by way of the mobile application or the website on the merchant device 104. At step 604, the merchant device 104 transmits the registration request to the payment network server 116. At step 606, the registration manager 210 generates the merchant identification code for the first merchant 102. At step 608, the registration manager 210 stores the merchant details and the merchant identification code as the merchant profile of the first merchant 102 in the memory 204. At step 610, the registration manager 210 transmits the acknowledgement, indicating successful registration of the first merchant 102 with the payment network for availing the on-behalf transaction service, to the merchant device 104.

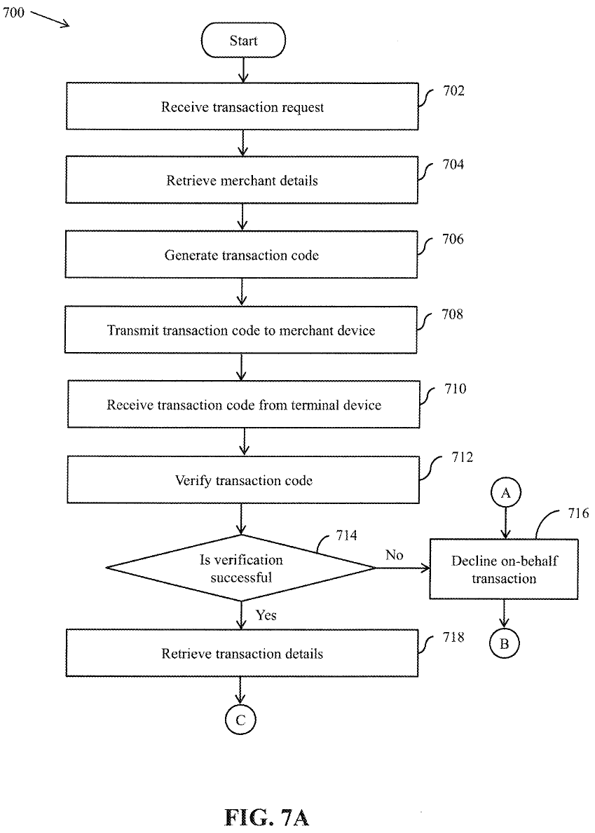

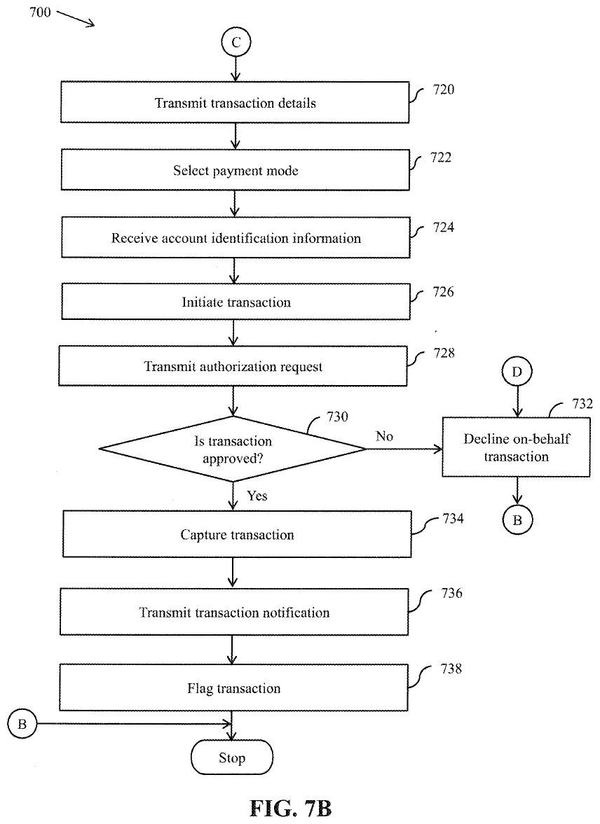

FIGS. 7A and 7B, collectively, represent a flow chart 700 that illustrates a method for processing transactions, in accordance with an embodiment of the present invention.

At step 702, the payment network server 116 receives the transaction request from the merchant device 104. The transaction request corresponds to the on-behalf transaction associated with the purchase made by the customer 106 from the first merchant 102. The transaction request includes the transaction details, such as the purchase amount associated with the purchase, and/or the merchant details (such as the merchant ID or merchant identification code associated with the first merchant 102). At step 704, the transaction manager 216 retrieves the merchant details of the first merchant 102 from the memory 204 based on the transaction request. In another embodiment, the transaction manager 216 retrieves the merchant details of the first merchant 102 from the transaction request and stores it in the memory 204.

At step 706, the code generator 212 generates the transaction code for the on-behalf transaction. At step 708, the transceiver 206 transmits the transaction code to the merchant device 104. The first merchant 102 provides the transaction code to the customer 106. The customer 106 goes to the second merchant location and provides the transaction code to the second merchant 110. The second merchant 110 inputs the transaction code by way of the terminal device 112. The terminal device 112 transmits the transaction code to the second acquirer server 114B. The second acquirer server 114B further transmits the transaction code to the payment network server 116.

At step 710, the transceiver 206 receives the transaction code form the terminal device 112. At step 712, the code generator 212 verifies the transaction code received from the terminal device 112. The transaction code is verified by comparing the received transaction code with the stored transaction code. The stored transaction code may be retrieved from the memory 204 based on the merchant ID or the merchant identification code associated with the received transaction code.

At step 714, a check is performed to determine whether verification of the transaction code is successful or unsuccessful. If, at step 714, verification of the transaction code is determined as unsuccessful, then step 716 is performed. At step 716, the transaction manager 216 declines the on-behalf transaction. The transaction manager 216 further transmits the transaction declined notification to the second acquirer server 114B by way of the transceiver 206. The second acquirer server 114B further transmits the transaction declined notification to terminal device 112. The terminal device 112 displays the transaction declined notification to the second merchant 110.

If, at step 714, verification of the transaction code is determined as successful, then step 718 is performed. At step 718, the transaction manager 216 retrieves the transaction details of the on-behalf transaction from the memory 204. At step 720, the transaction manager 216 transmits the transaction details to the second acquirer server 114B by way of the transceiver 206. The second acquirer server 114B transmits the transaction details to the terminal device 112. At step 722, the second merchant 110 selects a payment mode at the terminal device 112. Thereafter, the second merchant 110 uses the transaction card 108 for the conducting the on-behalf transaction. The terminal device 112 reads the account identification information of the customer account associated with the transaction card 108 and transmits the account identification information of the customer account to the payment network server 116.

At step 724, the transceiver 206 receives the account identification information of the customer account. At step 726, the transaction manager 216 initiates the on-behalf transaction based on the account identification information. At step 728, the transaction manager 216 transmits the authorization request to the issuer server 118 for authorizing the on-behalf transaction.

At step 730, a check is performed to determine approval of the on-behalf transaction. If, at step 730, it is determined that the on-behalf transaction is not approved, then step 732 is performed. At step 732, the issuer server 118 declines the on-behalf transaction. If, at step 730, it is determined that the on-behalf transaction is approved, then step 734 is performed. At step 734, the issuer server 118 captures the transaction details, for example, the purchase amount of the purchase. The issuer server 118 may debit the purchase amount from the customer account of the customer 106. The issuer server 118 further transmits a transaction notification indicating successful transaction to the payment network server 116.

At step 736, the payment network server 116 transmits the transaction notification to the second acquirer server 114B. The second acquirer server 114B further transmits the transaction notification to the terminal device 112. The payment network server 116 may also transmit the transaction notification to the merchant device 104. At step 738, the payment network server 116 flags the on-behalf transaction for the final settlement.

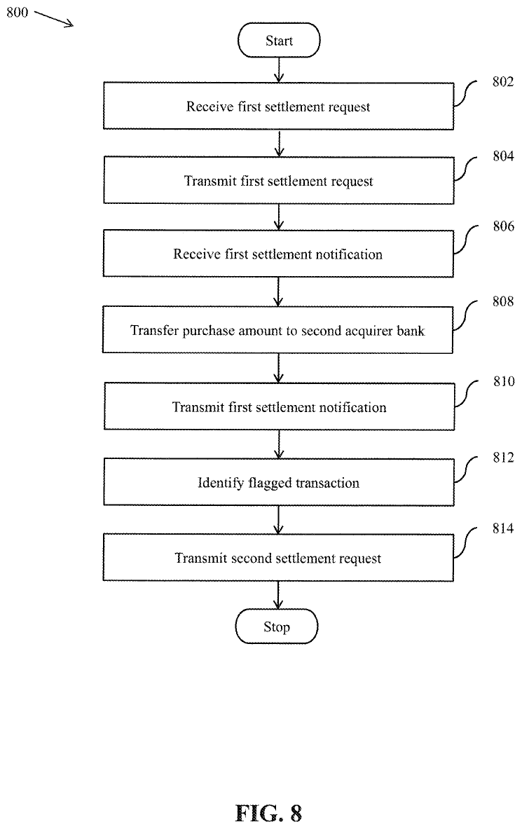

FIG. 8 represents a flow chart 800 that illustrates a method for settling the on-behalf transaction, in accordance with an embodiment of the present invention.

At step 802, the payment network server 116 receives the first settlement request from the second acquirer server 114B. At step 804, the payment network server 116 transmits the first settlement request to the issuer server 118. Based on the first settlement request, the issuer server 118 transfers the purchase amount, debited from the customer account of the customer 106, to the payment network. At step 806, the payment network server 116 receives the first settlement notification from the issuer server 118.

At step 808, the payment network transfers the purchase amount to the second acquirer. At step 810, the payment network server 116 transmits the first settlement notification to the second acquirer server 114B, indicating the transfer of the purchase amount. At step 812, the payment network server 116 identifies that the transaction is flagged as the on-behalf transaction. At step 814, the payment network server 116 transmits the second settlement request to the second acquirer server 114B. Based on the second settlement request, the second acquirer credits the purchase amount to the first acquirer. The first acquirer further credits the purchase amount to the first merchant account of the first merchant 102.

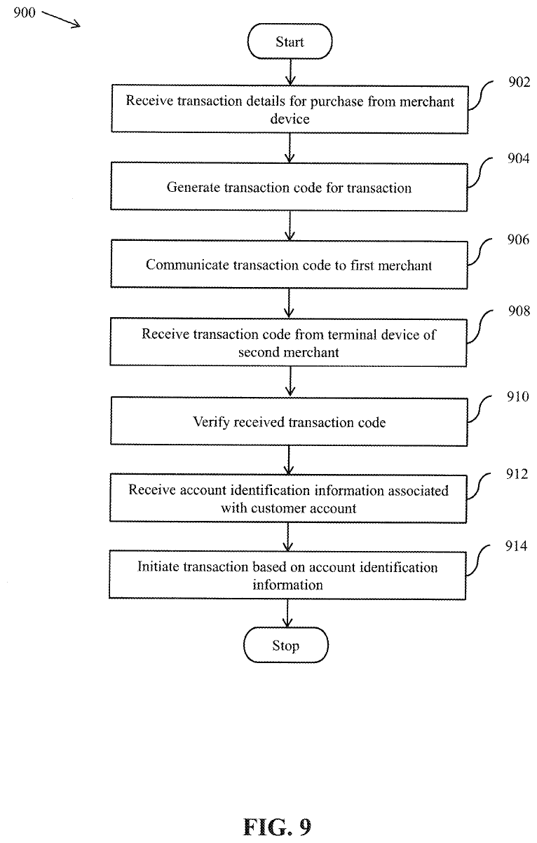

FIG. 9 represents a high-level flow chart 900 that illustrates the method for processing transactions, in accordance with an embodiment of the present invention.

At step 902, the payment network server 116 receives the transaction details of the transaction for the purchase that the customer 106 wants to make with a first merchant 102 associated with the first merchant location. At step 904, the payment network server 116 generates the transaction code in response to the received transaction details. At step 906, the payment network server 116 communicates the transaction code to the first merchant 102. The first merchant 102 provides the transaction code to the customer 106. At step 908, the payment network server 116 receives the transaction code from the terminal device 112, when the second merchant 110 (associated with the second merchant location) inputs the transaction code provided by the customer 106.

At step 910, the payment network server 116 verifies the received transaction code based on the transaction code communicated to the first merchant 102. At step 912, the payment network server 116 receives the account identification information of the customer account of the customer 106 from the terminal device 112, based on successful verification of the received transaction code. At step 914, the payment network server 116 initiates the on-behalf transaction based on the received account identification information.

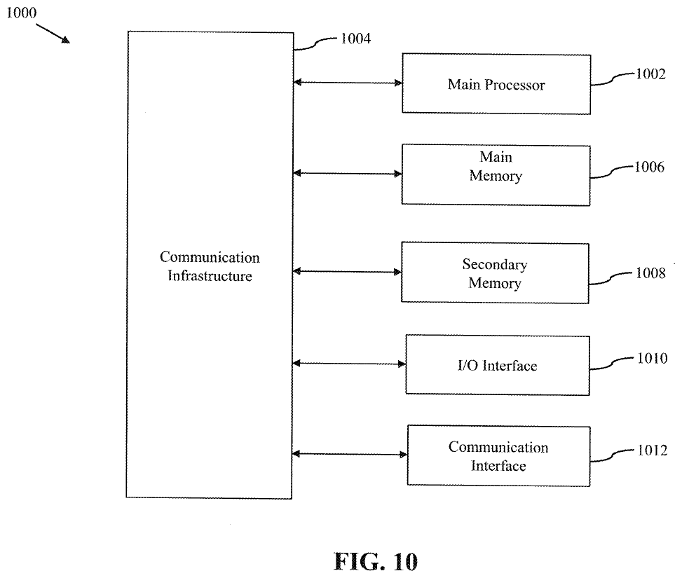

Referring now to FIG. 10, a block diagram that illustrates a system architecture of a computer system 1000, in accordance with an embodiment of the present invention, is shown. An embodiment of present invention, or portions thereof, may be implemented as computer readable code on the computer system 1000. In one example, the merchant device 104, the first and second acquirer servers 114A and 114B, the payment network server 116, and the issuer server 118 may be implemented in the computer system 1000 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 6-9.

The computer system 1000 includes a main processor 1002 that may be a special purpose or a general-purpose processing device. The main processor 1002 may be a single processor, multiple processors, or combinations thereof The main processor 1002 may have one or more processor “cores.” In one example, the main processor 1002 is an octa-core processor. Further, the main processor 1002 may be connected to a communication infrastructure 1004, such as a bus, message queue, the communication bus 208, multi-core message-passing scheme, and the like. The computer system 1000 further includes a main memory 1006 and a secondary memory 1008. Examples of the main memory 1006 may include RAM, ROM, dynamic RAM (DRAM), and the like. The secondary memory 1008 may include a hard disk drive or a removable storage drive, such as a floppy disk drive, a magnetic tape drive, a compact disc, an optical disk drive, a flash memory, and the like. Further, the removable storage drive may read from and/or write to a removable storage device in a manner known in the art. In one example, if the removable storage drive is a compact disc drive, the removable storage device may be a compact disc. In an embodiment, the removable storage unit may be a non-transitory computer readable recording media.

The computer system 1000 further includes an input/output (I/O) interface 1010 and a communication interface 1012. The I/O interface 1010 includes various input and output devices that are configured to communicate with the main processor 1002. Examples of the input devices may include a keyboard, a mouse, a joystick, a touchscreen, a microphone, and the like. Examples, of the output devices may include a display screen, a speaker, headphones, and the like. The communication interface 1012 may allow data to be transferred between the computer system 1000 and various devices that are communicatively coupled to the computer system 1000. Examples of the communication interface 1012 may include a modem, a network interface, i.e., an Ethernet card, a communications port, and the like. Data transferred via the communication interface 1012 corresponds to signals, such as electronic, electromagnetic, optical, or other signals as will be apparent to a person skilled in the art. The signals may travel via a communication channel (not shown) which transmits the signals to devices that are communicatively coupled to the computer system 1000. Examples of the communication channel include, but are not limited to, a cable, fiber optics, a phone line, a cellular phone link, or a radio frequency link.

Computer program medium and computer usable medium may refer to a non-transitory computer readable medium, such as the main memory 1006 and the secondary memory 1008, which may be a semiconductor memory such as a DRAM. The computer program medium may provide data that enables the computer system 1000 to implement the methods illustrated in FIGS. 6-9. In an embodiment, the present invention is implemented using a computer implemented application, the computer implemented application may be stored in a computer program product and loaded into the computer system 1000 using the removable storage drive or the hard disc drive in the secondary memory 1008, the I/O interface 1010, or the communication interface 1012.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor such as the main processor 1002 and a memory such as the main memory 1006 and the secondary memory 1008 implements the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Thus, various embodiments of the present invention facilitate a technique where customers (e.g., the customer 106) can use their transaction cards (e.g., the transaction card 108) to perform payment transactions for purchases at an outlet of a retailer (e.g., the first merchant 102) who currently does not have electronic payment infrastructure (e.g., POS devices) for conducting electronic transactions, or the electronic payment infrastructure currently is mal-functioning. In such scenarios, the customer 106 may make payments for the purchases from the first merchant 102 at another outlet of another retailer (e.g., the second merchant 110) using her transaction card 108. Thus, the customer 106 may not have to necessarily carry cash while making purchases from retailers, such as the first merchant 102. Also, the first merchant 102 does not suffer losses in terms of customers as well as revenue. Also, for conducting such transactions (e.g., on-behalf transactions), the second merchant 110 receives benefits and offers from payment networks (e.g., Mastercard). For example, the second merchant 110 may be freed from MDRs associated with new transactions (other than a new on-behalf transaction). Also, it creates a positive impact in her ratings in a MATCH database associated with the payment networks.

Techniques consistent with the present invention provide, among other features, systems and methods for processing payment transactions. While various exemplary embodiments of the disclosed system and method have been described above it should be understood that they have been presented for purposes of example only, not limitations. It is not exhaustive and does not limit the invention to the precise form disclosed.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A method for processing transactions, the method comprising:
receiving, by a server, from a merchant device of a first merchant, transaction details of a transaction for a purchase that a customer wants to make with the first merchant;
generating, by the server, a transaction code for the transaction in response to the received transaction details, wherein the transaction code is provided to the customer;
receiving, by the server, from a terminal device of a second merchant, the transaction code provided by the customer;
verifying, by the server, the transaction code received from the terminal device; and
initiating, by the server, the transaction based on a payment mode used by the customer to perform the transaction, when the transaction code is successfully verified, wherein a transaction offer is allocated to the second merchant after conducting the transaction.

2. The method of claim 1, further comprising:
receiving, by the server, from the merchant device, a registration request, including registration information of the first merchant, for registering the first merchant for an on-behalf transaction service.

3. The method of claim 1, wherein the transaction details include at least one of a purchase amount of the purchase or merchant details of the first merchant.

4. The method of claim 1, wherein the transaction code is associated with a validity period for initiating the transaction after generation of the transaction code.

5. The method of claim 1, further comprising:
rendering, by the server, on the terminal device, a user interface, when the second merchant selects a transaction option as an on-behalf transaction option on the terminal device, wherein the second merchant inputs the transaction code provided by the customer by way of the user interface.

6. The method of claim 1, further comprising:
identifying, by the server, the first merchant based on the transaction code, when the transaction code received from the terminal device is successfully verified; and
transmitting, by the server, the transaction details associated with the purchase to the terminal device.

7. The method of claim 1, further comprising:
receiving, by the server, account identification information of a customer account corresponding to the payment mode used by the customer to perform the transaction; and
initiating, by the server, an authentication of the customer based on the received account identification information, wherein the transaction is approved based on successful authentication of the customer, and wherein a purchase amount corresponding to the purchase is debited from the customer account, when the transaction is approved.

8. The method of claim 1, further comprising:
flagging, by the server, the transaction as an on-behalf transaction, when the transaction is approved; and
communicating, by the server, the transaction offer to the second merchant, when the transaction is flagged, wherein the transaction offer is pertinent to one or more new transactions other than a new on-behalf transaction conducted by the second merchant after successful processing of the transaction.

9. The method of claim 1, wherein the transaction offer is associated with a merchant discount rate (MDR) that is waived-off on the one or more new transactions, and wherein the transaction offer expires based on at least one of time or usage limit associated with the transaction offer.

10. The method of claim 1, further comprising:
determining, by the server, merchant account details of a merchant account associated with the first merchant based on the merchant details; and
initiating, by the server, a credit of the purchase amount to the merchant account based on the merchant account details.

11. A system for processing transactions, comprising:
a server comprising:
a processor that is configured to:
receive, from a merchant device of a first merchant, transaction details of a transaction for a purchase that a customer wants to make with the first merchant;
generate a transaction code for the transaction in response to the received transaction details, wherein the transaction code is provided to the customer;
receive, from a terminal device of a second merchant, the transaction code provided by the customer;
verify the transaction code received from the terminal device; and
initiate the transaction based on a payment mode used by the customer to perform the transaction, when the transaction code is successfully verified, wherein a transaction offer is allocated to the second merchant after conducting the transaction.

12. The system of claim 11, wherein the transaction details include at least one of a purchase amount of the purchase or merchant details of the first merchant.

13. The system of claim 11, wherein the transaction code is associated with a validity period for initiating the transaction after generation of the transaction code.

14. The system of claim 11, wherein the processor is further configured to:
render, on the terminal device, a user interface, when the second merchant selects a transaction option as an on-behalf transaction option on the terminal device, wherein the second merchant inputs the transaction code provided by the customer by way of the user interface.

15. The system of claim 11, wherein the processor is further configured to:
identify the first merchant based on the transaction code, when the transaction code received from the terminal device is successfully verified; and
transmit the transaction details associated with the purchase to the terminal device.

16. The system of claim 11, wherein the processor is further configured to:
receive account identification information of a customer account corresponding to the payment mode used by the customer to perform the transaction; and
initiate an authentication of the customer based on the received account identification information, wherein the transaction is approved based on successful authentication of the customer, and wherein a purchase amount corresponding to the purchase is debited from the customer account, when the transaction is approved.

17. The system of claim 11, wherein the processor is further configured to:
flag the transaction as an on-behalf transaction, when the transaction is approved; and
communicate the transaction offer to the second merchant, when the transaction is flagged, wherein the transaction offer is pertinent to one or more new transactions other than a new on-behalf transaction conducted by the second merchant after successful processing of the transaction.

18. The system of claim 11, wherein the transaction offer is associated with a merchant discount rate (MDR) that is waived-off on the one or more new transactions, and wherein the transaction offer expires based on at least one of time or usage limit associated with the transaction offer.

19. The system of claim 11, wherein the processor is further configured to:
determine merchant account details of a merchant account associated with the first merchant based on the merchant details; and
initiate a credit of the purchase amount to the merchant account based on the merchant account details.

20. A method for processing transactions, the method comprising:
receiving, by a server, from a merchant device of a first merchant, transaction details of a transaction for a purchase that a customer wants to make with the first merchant associated with a first merchant location;
generating, by the server, a transaction code for the transaction in response to the received transaction details;
communicating, by the server, the transaction code to the first merchant, wherein the first merchant provides the transaction code to the customer;
receiving, by the server, from a terminal device of a second merchant, the transaction code, when the customer provides the transaction code to the second merchant associated with a second merchant location;
verifying, by the server, the transaction code received from the terminal device;
receiving, by the server, from the terminal device, account identification information of a customer account corresponding to a payment mode used by the customer to perform the transaction, based on successful verification of the transaction code; and
initiating, by the server, the transaction based on the account identification information, wherein a purchase amount corresponding to the purchase is debited from the customer account of the customer, when the transaction is approved, and wherein a transaction offer is allocated to the second merchant after conducting the transaction.
